(19) United States
(12) Patent Application Publication
(10) Pub. No.: US 2024/0295460 A1
(43) Pub. Date: Sep. 5, 2024

(54) MULTI-AXIS SIMULATION TABLE

(71) Applicant: EMPULSE TEST SYSTEMS, LLC, Zeeland, MI (US)

(72) Inventors: Matt Johnson, Zeeland, MI (US); Doug Boals, Zeeland, MI (US); Mark Kammeraad, Zeeland, MI (US)

(21) Appl. No.: 18/588,355

(22) Filed: Feb. 27, 2024

Related U.S. Application Data
(60) Provisional application No. 63/488,079, filed on Mar. 2, 2023.

(51) Int. Cl. G01M 7/06

(52) U.S. Cl. CPC G01M 7/06

(57) ABSTRACT

A simulation table comprising: a table; a plurality of motors in communication with the table that each move the table in a first direction from a middle position to a lower position; and one or more pneumatic support systems that hold the table and any payload on the table and move the table in a second direction from the lower position to the middle position.

### CROSS REFERENCE TO RELATED APPLICATIONS

This application claims priority to U.S. Patent Application No. 63/488,079, filed on Mar. 2, 2023, the contents of which are incorporated by reference herein in the entirety.

### FIELD

The present teachings provide a simulation table that is movable about multiple axes and specifically a simulation table that includes electric motors with a pneumatic support system.

### BACKGROUND

Testing equipment may be used to test many different mechanisms and devices. Test equipment attempts to simulate real-life conditions so that durability of the mechanisms and devices may be determined. The test equipment may move along multiple axes.

Thus, there is a need for a high-speed simulation table. There is a need for a simulation table that produces high frequency vibrations. What is needed is a simulation table with a middle position where the pneumatic system supports a load. There is a need for a middle position where electric motors are free of carrying a load. What is needed is a simulation table where a pneumatic support system carries a load and generates a reactionary force relative to electric motors.

### SUMMARY

The present teachings provide: a simulation table comprising: a table; a plurality of motors in communication with the table that each move the table in a first direction from a middle position to a lower position; and one or more pneumatic support systems that hold the table and any payload on the table and move the table in a second direction from the lower position to the middle position.

The present teachings provide a need for a high-speed simulation table. The present teachings provide a simulation table that produces high frequency vibrations. The present teachings provide a simulation table with a middle position where the pneumatic system supports a load. The present teachings provider a middle position where electric motors are free of carrying a load. The present teachings provide a simulation table where a pneumatic support system carries a load and generates a reactionary force relative to electric motors.

### BRIEF DESCRIPTION OF THE DRAWINGS

FIG. 1 is an isometric view of a multi-axis simulation table.

FIG. 2A is a cut along the multi-axis simulation table along lines II-II.

FIG. 2A is a cross-sectional view of the linear actuator assembly of FIG. 1A along lines IIA-IIA.

FIG. 2B is a front view of a portion of the table of FIG. 2A.

FIG. 3 a side view of a motor and associated components of the multi-axis simulation table.

FIG. 4A is an end view of a motor with an air bag in an upper position.

FIG. 4B is an end view of the motor of FIG. 4A with the air bag moving between a middle position and a lower position.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings provide a multi-axis simulation table (simulation table) that is movable about six axes or six degrees of freedom. The simulation table may move side-to-side, up and down, left and right, tilt, pitch, yaw, bounce, vibrate, or a combination thereof. The simulation table may connect to a component or a component may be in contact with the simulation table. The simulation table may have a table that carries the component and the table may move one or directions, two or more directions, or three or more directions simultaneously.

The table functions to carry or connect to a component so that the component may be moved by the table to test the component. The table may have an upper surface that is generally planar. The table may be made of any material. The table may be made of our include metal, plastic, wood, steel, stainless steel, iron, or a combination thereof. The table may have an upper surface that carries a component. The table may have a lower surface that connects to one or more motors, one or more pneumatic support systems, or both. The lower surface of the table may include one or more table connectors.

The table connectors function to connect the table to one or more motors, one or more pneumatic support systems, or both. The table connections may be located at an angle relative to the upper surface of the table, another table connection, or both. The table connections may extend at an angle so that when a force is acted upon a table connection the table moves in one or more directions. The table connection may extend at an angle of about 5 degrees or more, 15 degrees or more, 30 degrees or more, or about 45 degrees or more relative to the upper surface of the table. The table connection may extend at an angle of about 90 degrees or less, 75 degrees or less, about 60 degrees or less, or about 50 degrees or less relative to the upper surface of the table. A first table connector may extend at an angle relative to a second table connector so that when a first force acts on the first table connector the table moves in a first direction and when a second force acts on the second table connector the table moves in a second direction that is different than the first direction. The table connections may be located at an angle relative to one another (e.g., a first table connector and a second table connector). Two table connectors may be separated by an angle of about 5 degrees or more, 15 degrees or more, 30 degrees or more, or about 45 degrees or more relative to each other. Two table connectors may be separated by an angle of about 90 degrees or less, 75 degrees or less, about 60 degrees or less, or about 50 degrees or less relative to one another. Each table connector may include or be connected to a rotary joint.

The rotary joint functions to permit rotational movement of a lifting support relative to the table. The rotary joint may permit movement of the lifting support relative to the table in one or more directions, two or more directions, three or more directions, four or more direction, or six or less directions. The rotary joint may include a ball and socket. The rotary joint may connect to a lifting support so that the lifting support may move the table.

The lifting support functions to move the table, apply a force to the table, support the table, or a combination thereof. The lifting support may be a rod, a arm, a bar, a rigid device, or a combination thereof. The lifting support may be solid, hollow, two or more pieces, three or more pieces, or a combination thereof. The lifting support may impart a force on the table through the rotary joints. The simulation table may include two or more, four or more, or six or more lifting supports. The simulation table may include 20 or less, 15 or less, 12 or less, 10 or less, or 8 or less lifting supports. Each lifting support may be connected to the table on a first end and a lever arm on a second side.

The lever arm functions to move a lifting support. The lever arm may be moved by a motor. The lever arm may be connected to a shaft of the motor. The lever arm may translate rotational movement into linear movement. The lever arms may be one or more arms that connect to the lifting support. The lever arms may be connected to a lifting support by a fastener, a movable member, or both. The lever arms may provide a force from a motor to the lifting support. The lever arms may each be moved individually. The lever arms may be moved by a controller controlling each motor individually so that each motor operates based upon a control from the motor. The lever arms may be connected to a shaft of a motor so that when the motor moves the shaft the lever arms are moved.

The motor functions to provide a force, move a lifting support, translate a part of the table, or a combination thereof. The motor may be an electric motor, pneumatic motor, hydraulic motor, servo motor, stepper motor, or a combination thereof. Each of the motors may provide a sufficient amount of force to move a mass of about 20 kg or more, 40 kg or more, about 50 kg or more, about 75 kg or more, about 100 kg or more, about 200 kg or more, or about 500 kg or more. Thus, if one motor can move 100 kg and there are 8 motors present 800 kg may be moved. The motor may be connected to a floor, a platform, or both. The motor may generate a force on demand. The motor may generate a force only in a first direction. The motor when off may be neutral or free moving. The motor may have a shaft that moves in a first direction when the motor is on and in a second direction when the motor is off.

The shafts function to impart a force on the table when the motors are activated (turned on). The shafts rotate in a first direction when the motors are powered, and the shafts may rotate in a second direction when the motors are free of power. The shafts may freely rotate when the motor is not being powered. The shafts may lift the table by imparting a force on the lifting support through the lever arm and rotary joint. The shaft may be supported by a bearing.

The bearings function to support the shaft and allow the shaft to rotationally move. The bearings may bearing may include one or more races, two or more races, three or more races, or four or less races. The bearings may include balls or cylinders. The bearings may allow the shaft to freely rotate. The bearings may allow the motor and the pneumatic support system to move the shaft.

The pneumatic support system may move the shaft, the table, or both from an upper position to a middle position, a lower position to the middle position, or both. The pneumatic support system may provide a first level of movement to the table. The pneumatic support system may generate an initial lift or move the table to a middle position so that the table may move up and down. The pneumatic support system may support the table and a load when motors are off or free rotating. The pneumatic support system may move the shaft a first distance so that the shaft moves the lifting support and the associated table. Each motor may have a pneumatic support system. Some of the motors may have a pneumatic support system. The pneumatic support system includes one or more air bags and one or more air bag linkages.

The air bags function to move the shaft, the table, or both when a fluid is introduced into the air bags. The air bags may lift a similar mass as the motors. The air bags may each lift about 500 kg or more or even about 1000 kg or more. The air bags may lift a load to a static state, lifting state, or middle position when the air bag are full. The air bags may move a shaft through one or more air bag linkages.

The air bag linkages may connect the air bag to a motor shaft. The air bag linkages may move the shaft when the air bags are inflated and deflated. The air bag linkages may directly connect the air bags to the shaft. The air bag linkages may translate a force as a cylinder interior moves relative to a cylinder exterior of the air bag.

The cylinder exterior may be a fixed part of the air bag. The cylinder exterior may be a sold part of the air bag. The cylinder exterior may be circular, cylindrical, geometric, symmetrical, asymmetrical, or a combination thereof. The cylinder exterior may be free of movement as a fluid extends into the air bag. The cylinder exterior may direct movement of the cylinder interior.

The cylinder interior functions to move relative to the cylinder exterior. The cylinder interior may move in and out of the cylinder exterior. The cylinder interior moves axially along a longitudinal axis of the air bag. The cylinder interior may increase a length of the air bag. The cylinder interior may push against a surface to provide a force on the shaft. The cylinder interior may move the shaft so that the shaft, table, or both are moved to a middle position. The cylinder interior may create a reactionary force. For example, the motor may move the shaft in a first direction and the cylinder interior may counteract that force with a reactionary force that moves the shaft in a second direction. The cylinder interior may act as a spring. The cylinder interior may store energy and then release the energy when the motor is off so that the motor shaft is moved back to starting state or middle position. The cylinder interior may be filled with a compressible fluid, a non-compressible fluid, or both. The cylinder interior may be filled with a fluid that may move into a reservoir upon a force acting on the air bag.

The reservoir functions to create a closed fluid circuit. The reservoir receives fluid from the air bag when the air bag is compressed, the motor is activated, the shaft rotates, or both. The reservoir provides fluid to the air bag when a motor is turned off, the air bag in a lower portion, or both so that the shaft, the air bag, or both are moved back to a neutral position (e.g., middle position). The reservoir may have a volume that is larger than a volume of the air bag. The volume of the reservoir may be about two times or more, five times or more, 10 times or more, 15 times or more, 20 times or more, or 50 times or more the volume of the air bag. The reservoir and the air bag may have a stead state where the air bag is filled to hold a static load of the table and the payload. Then when a dynamic load is applied by the motor, fluid may move out of the air bag and into the reservoir. However, as the fluid moves between the air bag and the reservoir about 10 percent or less, 7 percent or less, or 5 percent or less of a total air volume moves between the air bag and the reservoir. The total volume (e.g., volume of reservoir and air bag) may minimize an amount of pressure change throughout a stroke (e.g., rotation of the shaft by the motor). For example, the pressure may change by about 10 percent or less, about 5 percent or less, or about 1 percent or less due to such a small amount of fluid exiting the air bag into the reservoir due to the volume difference between the air bag and the reservoir. Each air bag may have a reservoir. All of the air bags may be connected to a single reservoir. The air bag may be in an upper position when little or no fluid is being provided by the reservoir.

The upper position may be a position where the table is free of a payload (e.g., component). The table may have a steady state when there is no payload so that the air bag, the table, or both are free of a load. The upper position may have the air bag free of contact with a surface. The upper position may be where the cylinder interior is substantially retracted into the cylinder exterior and is free of contact with any surfaces. The cylinder interior may be supplied with fluid so that the air bag moves from the upper position to the middle position.

The middle position functions to hold a static load (e.g., table and payload) at a predetermined position. The middle position function to lift the table and payload a distance above a surface. The middle position may be a position where the table is movable both up and down. The middle position may be where the air bag is loaded to a first state. The middle position may be where the cylinder interior extends out of the cylinder exterior to lift the table. The middle position may hold a static load. The air bag may be compressed when a dynamic load is applied to the shaft by the motor so that the air bag moves from the middle position to a lower position.

The lower position may be a position where the air bag is loaded so that the table moves in the direction of the air bag. The lower position may move the table in one direction while that air bag is in the lower position. One air bag may be in a lower position while the other air bags are in a middle position. The air bags may be compressed in a sequence, a random sequence, a chain or movements so that the air bags are all in varying states between the middle position and the lower position. The air bags when in the lower position may spring the table back to the middle position. The air bags may rotate the shaft to a neutral state (e.g., middle position). The air bags when in the lower position may back drive the motor through the shaft so that the table is moved back to a middle position. The lower position may cause the portion of the table to move.

Each motor and each lifting support may move the table in one degree of freedom. Thus there may be six motors, six pneumatic support systems, six movement directions, or a combination thereof.

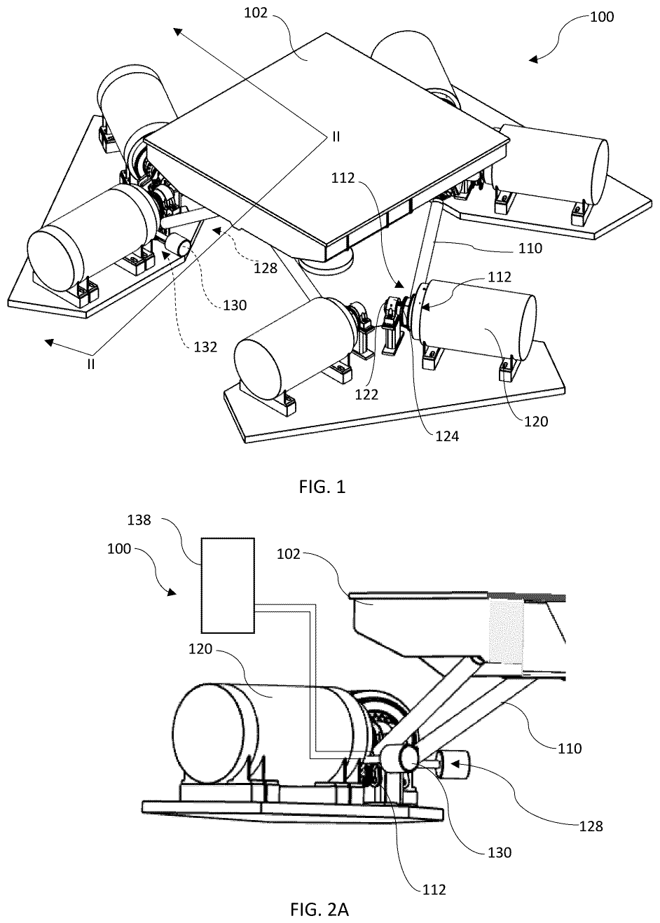

FIG. 1 is an isometric view of a multi-axis simulation table 100. The multi-axis simulation table 100 has a table 102, a lifting support 110, and a pneumatic support system 128. The table 102 as shown is a flat table where one or more components may be connected or placed so that the components may be moved in a predetermined manner or in a simulation manner. The table 102 is connected to a plurality of lifting supports 110 at a first end. The lifting supports 110 is connected to a lever arm 112 at a second end proximate to a motor 120. The motor 120 rotates a shaft 122. The shaft 122 is connected to a lever arm 112 that moves the lever arm 112 and a portion of the table 110. The shaft 122 is supported by one or more bearings 124.

The shaft 122 is in communication with a pneumatic support system 128. The pneumatic support system 128 includes an air bag 130 connected to the shaft 122 by an air bag linkage 132. The air bag 130 has a cylinder exterior 134 and a cylinder interior 136 that is movable relative to the cylinder exterior 134. As the motor 120 moves the shaft 122 the pneumatic support system 128 proves some resistance to the movement so that the shaft may be rapidly be moved back and forth by forces from the motor 120 and opposing forces by the pneumatic support system 128.

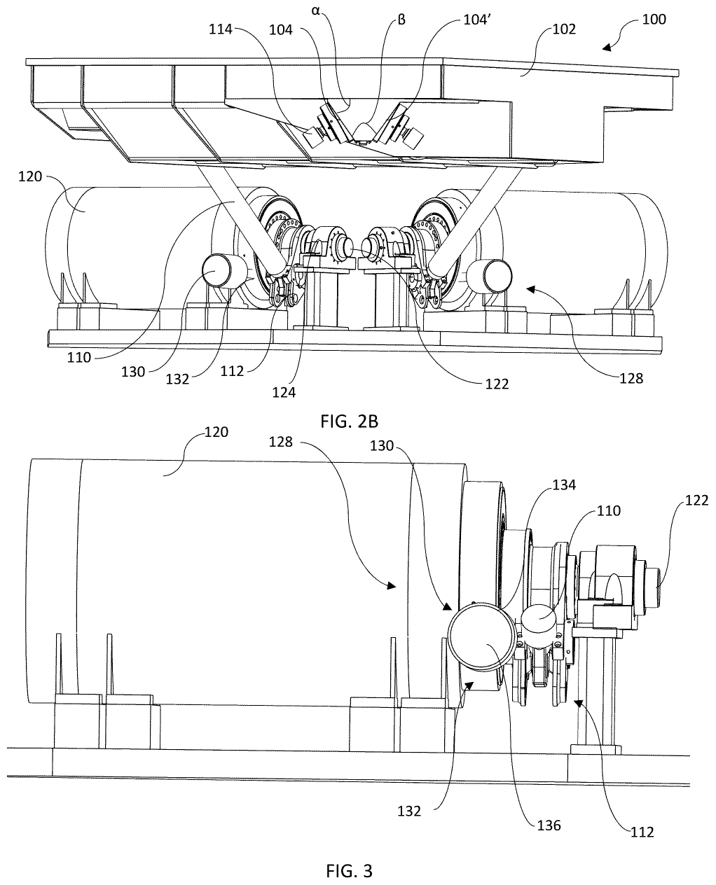

FIG. 2A is a partial cross-sectional view of the multi-axis simulation table 100 along lines II-II of FIG. 1. The multi-axis simulation table 100 has a table 102 connected to lifting supports 110 that move the table 102 The lifting supports 110 are each connected to a motor 120 by a lever arm 112 so that as the motor 120 moves, the lever arm 112 moves the lifting support 110. A pneumatic support system 128 is also in communication with the table 102. The pneumatic support system 128 has an air bag 130 that creates a reactionary force opposite to the motor 120. As is moved into and out of the air bag 130, fluid moves between the air bag 130 and a reservoir 138.

FIG. 2B is side plan view of the multi-axis simulation table 100 of FIG. 2A. The multi-axis simulation table 100 has a table 102. The table 102 has a table connector 104 that creates connections with a rotary joint 114. The table connector 104 is located at an angle (α) relative to a top of the table 102 and an angle (β) relative to an opposing table connector 104′. The table connectors 104 and 104′ assist in moving the table 102 in a predetermined manner in predetermined directions. The rotary joints 114 are each connected to a lifting support 110.

The lifting supports 110 are connected to the rotary joint 114 at a first end and at a shat 122 of the motor 120 at a second end. The lifting supports 110 transfer energy from the motor 120 to the table 102 to move an object on or connected to the table 102. A lever arm 112 is connected to the second end of the lifting support 110. The shaft 122 of the motor 120 is retained within a bearing 124 that provides rotational support to the shaft 122. The motor 120 is supported by a pneumatic support system 128.

The pneumatic support system 128 includes an air bag linkage 132 that connects an air bag 130 to the shaft 122. The air bag 130 includes a cylinder exterior 134 that is static and a cylinder interior 136 that moves in an out of the cylinder exterior 134.

FIG. 3 is a side view of the lifting support 110, motor 120, and pneumatic support system 128. The motor 110 has a shaft 122 that is moved by the motor 110. A lever arm 112 is connected to the shaft 122 so that as the shaft 122 moves the lever arm 112 moves a lifting support 110 in connection with the table of FIG. 1. The pneumatic support system 128 has an air bag 130 that is connected to the shaft 122 by an airbag linkage 132. The air bag 130 has a cylinder exterior 134 and a cylinder interior 136 that moves relative to the cylinder exterior 134.

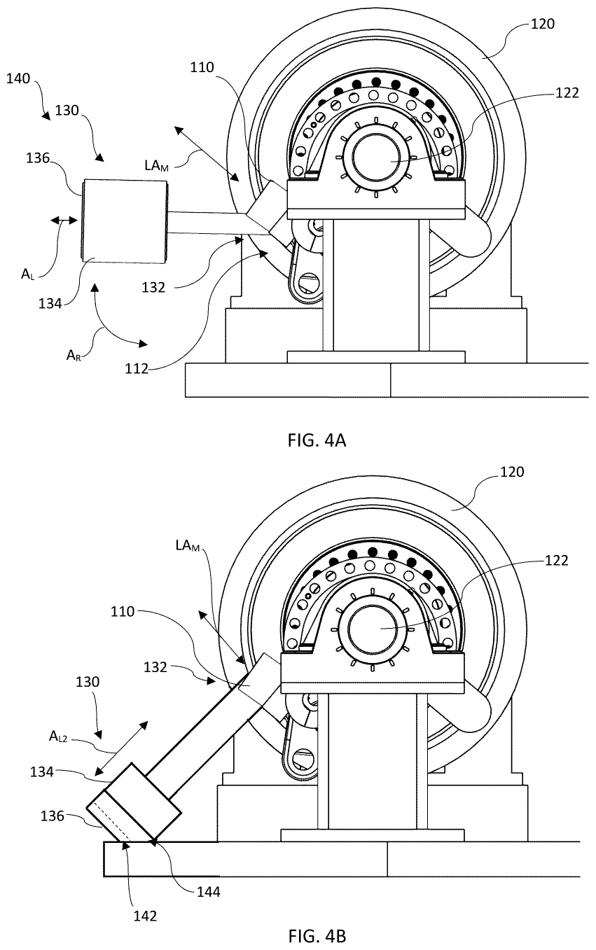

FIG. 4A is a side view of the motor 120 and corresponding pneumatic support system 128. The motor 120 has a shaft 122 that is in communication with a lever arm 112 and lifting support 110. As the shaft 122 of the motor rotates, the lever arm 112 moves with the shaft 122 and the lifting support 110 is moved longitudinally along the directions LA_{M}. As shown the direction LA_{M} is a movement that generally moves the table of FIG. 1 up and down.

The pneumatic support system 128 is shown in the upper position 140. The pneumatic support system 128 has an air bag 130 that is connected to the shaft 122 via an air bag linkage 132. The air bag 130 includes a cylinder exterior 134 and a cylinder interior 136. The cylinder interior 136 moves relative to the cylinder exterior 134 in the direction A_{L}. However, when the pneumatic support system 128 is in the upper position 140 the cylinder interior 136 is free of contact with any components or devices that cause a force on the shaft 122.

FIG. 4B illustrates the pneumatic support system 128 moving between the middle position 142 and lower position 144 in the direction A_{L2}. The pneumatic support system 128 includes an air bag 130 with a cylinder exterior 134 and a cylinder interior 136. The cylinder interior 136 moves towards and away from the cylinder exterior 136 to provide a force on the shaft 122 via the air bag linkage 132. Thus, for example, the motor 120 applies a force in a first direction so that the lifting support 100 is moved in a first direction along L_{AM} causing the air bag to move from a middle position 142 to a lower position 144 where the air bag 130 compresses and the corresponding table is moved in a first manner. Once the motor 120 stops applying a force to the shaft 122, the air bag 130 generates a return force that moves the air bag 130 and associated shaft 122 from the lower position 144 to a middle position 142 in a reverse of the direction A_{L2} to counter act the movement from the motor 120 and move the table in a second manner.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

### ELEMENT LIST

100 Multi-axis Simulation Table
102 Table
104 Table Connector
110 Lifting Support
112 Lever Arm
114 Rotary Joint
120 Motor
122 Shaft
124 Bearing
128 Pneumatic Support System
130 Air Bag
132 Air Bag Linkage
134 Cylinder Exterior
136 Cylinder Interior
138 Reservoir
140 Upper Position
142 Middle Position
144 Lower Position

We claim:

1. A simulation table comprising:
a table;
a plurality of motors in communication with the table that each move the table in a first direction from a middle position to a lower position; and
one or more pneumatic support systems that hold the table and any payload on the table and move the table in a second direction from the lower position to the middle position.

2. The simulation table of claim 1, wherein the one or more pneumatic support systems include an air bag that expandable in a longitudinal direction to move the table from the lower position to the middle position.

3. The simulation table of claim 1, wherein each of the plurality of motors are connected to the table by a lifting support.

4. The simulation table of claim 3, wherein a rotary joint connects the lifting support to the table.

5. The simulation table of claim 1, wherein the table has a bottom surface has a plurality of table connectors.

6. The simulation table of claim 5, wherein each of the table connectors extend at an angle relative to a top surface of the table at an angle of about 15 degrees or more and about 90 degrees or less.

7. The simulation table of claim 5 wherein two adjacent table connectors of the plurality of table connectors are located at an angle of about 15 degrees or more and about 90 degrees or less.

8. The simulation table of claim 1, wherein the plurality of motors are six motors.

9. The simulation table of claim 1, wherein the pneumatic support systems are each connected to a shaft of one of the plurality of motors.

10. The simulation table of claim 1, wherein each of the one or more pneumatic support systems include an air bag.

11. The simulation table of claim 10, wherein the air bag includes a cylinder exterior and a cylinder interior that moves relative to the cylinder exterior.

12. The simulation table of claim 1, wherein the one or more pneumatic support systems include a reservoir.

13. The simulation table of claim 12, wherein each of the one or more pneumatic support systems include one of the reservoirs.

14. The simulation table of claim 1, wherein each of the one or more pneumatic support systems include an air bag and a reservoir.

15. The simulation table of claim 14, wherein a volume of the reservoir is about 5 times or more larger than a volume of the air bag.

16. The simulation table of claim 14, wherein a volume of the reservoir is about 20 times or less larger than a volume of the air bag.

17. The simulation table of claim 1, wherein each of the plurality of motors provide a force to the table through a lever arm.

18. The simulation table of claim 17 wherein the lever turns a rotational force into a longitudinal force.
